(19) United States
(12) Patent Application Publication
(10) Pub. No.: US 2024/0381018 A1
(43) Pub. Date: Nov. 14, 2024

(54) PROTECTIVE, MULTIFUNCTION EARBUD SYSTEM

(71) Applicant: Reviv3 Acquisition Cor. d.b.a. AXIL and Associated Brands, Corp., Draper, UT (US)

(72) Inventor: Weston Harris, Draper, UT (US)

(21) Appl. No.: 18/314,708

(22) Filed: May 9, 2023

(51) Int. Cl. H04R 1/10

(52) U.S. Cl. CPC H04R 1/1041; H04R 1/1016; H04R 1/1025; H04R 2420/07; H04R 2430/01

(57) ABSTRACT

A protective, multifunction earbud system. The earbuds are shaped to fit within an ear canal and a concha of an ear of a wearer and provide hearing protection and audio outputs. The earbuds couple wirelessly to a smartphone or tablet and have two input mechanisms: a touch surface used to control music and telephone calls, and a physical button used to control hearing protection measures.

### BACKGROUND

Earbuds continue to be a valuable tool for many people and are used for much more than just listening to music. Nearly every person today has a smartphone, tablet, laptop, or other electronic device that is able to connect with earbuds to provide directions, participate in virtual reality and augmented reality experiences, and more. Nevertheless, there remains a need in the art for audio devices to protect the wearer's delicate ears in an increasingly noisy environment.

### SUMMARY

Embodiments of the present disclosure are directed to A protective, multifunction earbud system including a left earbud and a right earbud. Each of the left earbud and right earbud individually includes a body having a kidney shape and being configured to house electronics including a battery, logic, wireless communication means, a microphone, and a speaker, and a stem protruding from the body and being acoustically coupled to the speaker and configured to extend into an ear canal of a wearer. The earbuds also include a cushion attached to the stem and being configured to facilitate a comfortable fit within the ear canal. The body fits within a concha of the ear of the wearer. The earbuds include a touch surface on the body and being oriented to face outwardly from the wearer's ear that is associated with a first plurality of predetermined commands. The earbuds also include a mode swap button comprising a physical button located on a perimeter of the body that is associated with a second plurality of predetermined commands.

Further embodiments of the present disclosure are directed to a protective multifunctional earbud that includes electronics comprising logic, a battery, a wireless transceiver, a microphone, and a speaker. The earbud also includes a body housing the electronics and being shaped to fit within a concha of an ear of a wearer of the earbud, and a stem protruding from the body and being configured to fit within an ear canal of the wearer and to channel sound into the ear canal of the wearer. There is a touch surface on the body that is responsive to capacitive touch inputs that are for audio controls, and a physical button on the body separate from the touch surface that is responsive to presses. Presses of the physical button alter a hearing protection level of the earbud.

Still further embodiments of the present disclosure are directed to a system for protecting a wearer's hearing while providing audio outputs. The system includes an earbud having a stem that fits within a wearer's ear canal and a body integral to the stem that fits within a concha of the wearer's ear. The earbud also includes a touch surface on the earbud being configured to receive touch inputs that control music and telephone call operation of a smartphone to which the earbud is wirelessly coupled, and logic in the earbud that receives incoming sound, digitally compresses the sound, and presents the sound to the speaker, wherein the logic limits output sound to a decibel limit of approximately 85 decibels.

### BRIEF DESCRIPTION OF THE FIGURES

FIG. 1 is a side view of a protective, multifunction earbud system according to embodiments of the present disclosure.

FIG. 2 is a top view of the protective, multifunction earbud system according to embodiments of the present disclosure.

FIG. 3 is a close-up, side view of a left earbud according to embodiments of the present disclosure.

FIG. 4 is a partial view of the protective, multifunction earbud system according to embodiments of the present disclosure.

FIG. 5 is a partial view of the protective, multifunction earbud system according to embodiments of the present disclosure.

FIG. 6 is a side view of a left earbud and associated controls according to embodiments of the present disclosure.

FIG. 7 is a side view of a right earbud and associated controls according to embodiments of the present disclosure.

FIG. 8 is a front view of a case that houses and protects the earbuds of the protective, multifunction earbud system according to embodiments of the present disclosure.

FIG. 9 shows the case according to embodiments of the present disclosure.

FIG. 10 shows the receptacle with the lid removed according to embodiments of the present disclosure.

FIG. 11 is a top view of the receptacle according to embodiments of the present disclosure.

### DETAILED DESCRIPTION

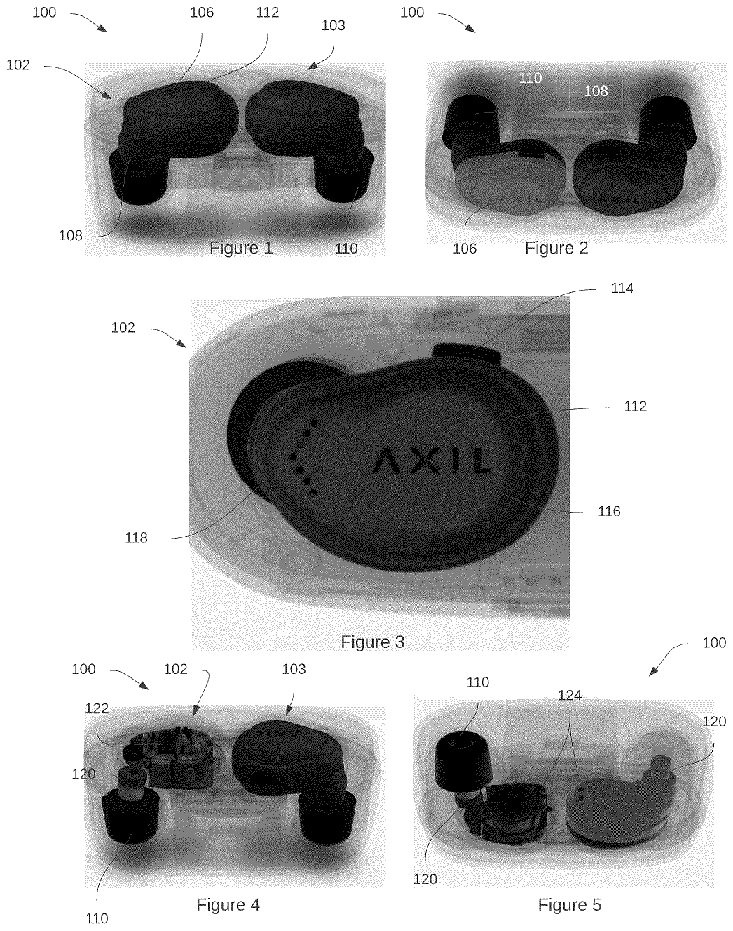

Below is a detailed description according to various embodiments of the present disclosure. FIG. 1 is a side view of a protective, multifunction earbud system 100 according to embodiments of the present disclosure. The system 100 includes a left earbud 102 and a right earbud 103 that are placed within an ear of a user and deliver audio into the user's ear including music, telephone calls, and voice instructions to and from a phone or other electronic device. The protective, multifunction earbud system 100 also provides for hearing protection in addition to audio outputs. FIG. 2 is a top view of the protective, multifunction earbud system 100 according to embodiments of the present disclosure. Elements of the system 100 are shown in both FIGS. 1 and 2 where like references indicate like features.

The earbuds 102, 103 are symmetrical and otherwise indistinguishable in shape and appearance. Throughout this disclosure reference made to a single earbud, left or right, applies equally to the other earbud without loss of generality. In some cases, there are differences between left and right, and except where specifically claimed, characteristics of the left earbud can also be characteristics of the right earbud, and vice versa.

The earbuds 102, 103 include a body 106 that houses electronics, including logic, battery, wireless communication means, a microphone, and a speaker. The earbuds 102, 103 also include a stem 108 that protrudes away from the body 106 and into the ear canal of the user. The earbuds 102, 103 can fit within the concha of the ear. The stem 108 includes a cushion 110 that is a flexible, soft, pliable component that allows a comfortable fit within the ear of the user that is comfortable enough for lengthy, all-day use.

The earbuds 102, 103 include a touch surface 112, also referred to herein as an “input surface” or a “surface.” The surface 112 is a generally flat, kidney-shaped surface that conforms to a concha of a user's ear and is used as a capacitive touch input surface such as is found in electronic devices such as smartphones and tablets. The earbuds 102, 103 also include a mode swap button 114 that is a deflectable button that may be a flexible membrane or other suitable button whose operation is given in detail later in this disclosure. In some embodiments the mode swap button 114 is positioned on the perimeter of the body 106. In some embodiments the mode swap button 114 is at a top edge of the body 106.

FIG. 3 is a close-up, side view of a left earbud 102 according to embodiments of the present disclosure. The surface 112 is visible and may have a logo 116. The logo 116 can be formed of shaped holes that can serve as microphone ports. In addition, there may be additional microphone ports 118 in an attractive, arrow pattern. The cushion 110 is visible protruding behind the earbud 102.

FIG. 4 is a partial view of the protective, multifunction earbud system 100 according to embodiments of the present disclosure. The left earbud 102 has components removed to avoid obscuring features within the earbud 102. The earbud 102 includes electronics 122 such as a printed circuit board, logic, memory, etc. and other common features of small electronic devices. The stem (not shown) is also removed showing an audio port 120 that channels sound from the speaker (not shown, within the electronics 122) to the ear of the user.

FIG. 5 is a partial view of the protective, multifunction earbud system 100 according to embodiments of the present disclosure. The back of the earbuds 102, 103 includes contacts 124 that are used to charge a battery within the earbuds 102, 103.

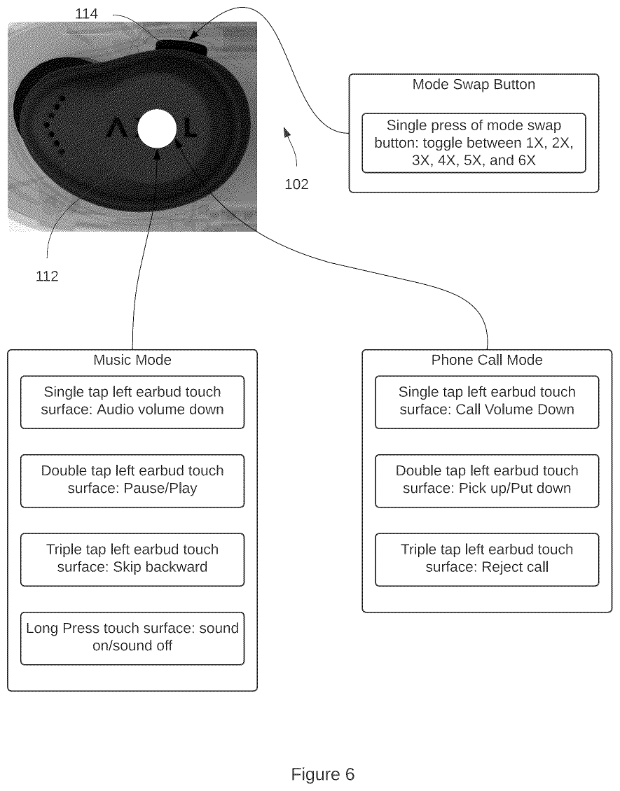

FIG. 6 is a side view of a left earbud 102 and associated controls according to embodiments of the present disclosure. The earbud system 100 allows for audio such as music and telephone calls and interactions with a smart phone or other electronic device using a voice assistant such as Apple's SIRI or Amazon's ALEXA or the like. In addition, the earbud system 100 allows for hearing protection that is seamlessly integrated into the functionality of the earbud system 100. The inputs for the earbud 102 are through the surface 112, and the mode swap button 114.

The mode swap button 114 enables the protective, multifunction earbud system 100 to toggle between modes of hearing protection. 1× hearing protection level is a natural, unaltered audio setting in which no mitigation, dampening, or muting of incoming audio is applied. Levels 2×, 3×, 4×, 5×, and 6× are reachable via a single button press that progresses the status in increments of one level. In some embodiments the earbud 102 can give an audible indication of the level such as a voice saying “hearing protection level n.” In other embodiments a series of beeps can be given. The beeps can be different audio levels indicating a level of hearing protection. The mode swap button 114 is a physical button that depresses when pressed. The mode swap button 114 can be a flexible membrane, or it can include other resilient features. In some embodiments the mode swap button 114 can be a capacitive button that gives haptic feedback such as a vibration to indicate a successful press.

In some embodiments the hearing protection measures comprise an upper limit for output sound into the ear of the wearer. In some embodiments the earbuds include logic that receives ambient sound, processes the ambient sound by digitally compressing the sound, and outputting a new digital signal. In the new digital signal, sounds above the upper limit are reduced down to the upper limit. In some embodiments the upper limit is adjustable such as by pressing the mode swap button. In some embodiments the upper limit is approximately 85 decibels. In some embodiments the hearing protection measures include an active noise cancellation signal.

In some embodiments the hearing protection measures offered by the protective, multifunction earbud system 100 of the present disclosure include volume muting or mitigation such as by dampening or by volume reduction. The system 100 accordingly operates as a combination earbud and hearing aid. In some embodiments the system 100 can also provide active noise cancelling that scales from 1-6, 1 being slight, and 6 being significant. In some embodiments the hearing protection measures scale linearly. In other embodiments the hearing protection measures scale non-linearly with the natural scale of human ears.

The input surface 112 can include a capacitive touch-responsive circuit that is capable of detecting taps, including single and multiple taps, taps of varying timing, timings between taps, etc. The earbuds are operable in a music mode and in a telephone mode. In the music mode, a single tap of the left earbud 102 on the touch surface 112 causes audio volume to be diminished. A double tap of the left earbud 102 on the touch surface 112 denotes a pause/play command. A triple tap of the left earbud 102 on the touch surface 112 effects a skip backward to the previous track. A long press on the left earbud 102 on the touch surface turns the sound entirely off or entirely on in a toggle.

In the phone mode, a single tap of the left earbud 102 on the touch surface 112 causes call volume to be diminished. A double tap of the left earbud 102 on the touch surface 112 causes the phone call to be picked up if a call is ringing, and to terminate an active call. A triple tap on the left earbud 102 on the touch surface 112 causes an incoming call to be rejected. A rejected call can be sent to voice mail or another outcome based on the settings of the phone to which the earbuds are paired such as via Bluetooth or another wireless protocol.

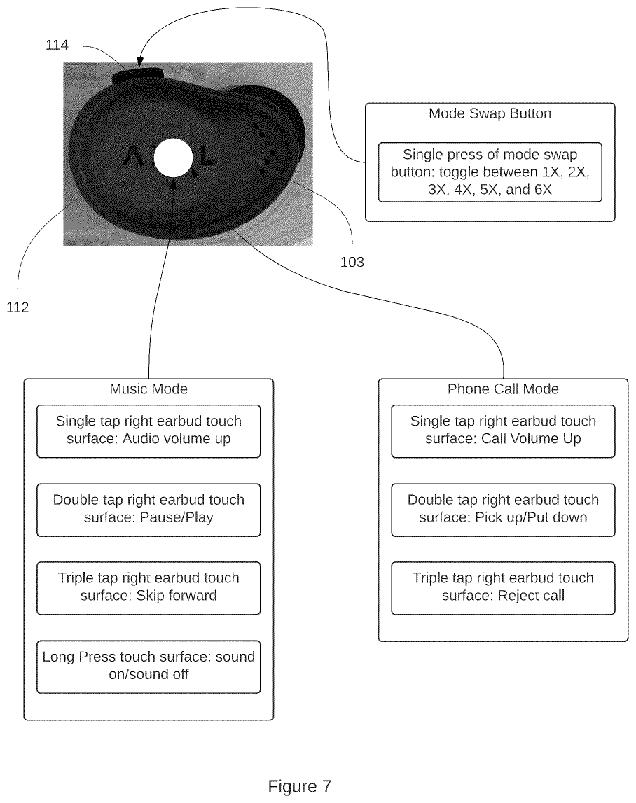

FIG. 7 is a side view of a right earbud 103 and associated controls according to embodiments of the present disclosure. The mode swap button 114 is identical on this earbud 103 to the appearance, and operation to the left earbud 102 except where differences are denoted herein. In the music mode, a single tap of the right earbud 103 on the touch surface 112 causes audio volume to be increased. A double tap of the right earbud 103 on the touch surface 112 denotes a pause/play command. A triple tap of the right earbud 103 on the touch surface 112 effects a skip forward to the next track. A long press on the right earbud 103 on the touch surface turns the sound entirely off or entirely on in a toggle.

In the phone mode, a single tap of the right earbud 103 on the touch surface 112 causes call volume to be increased. A double tap of the right earbud 103 on the touch surface 112 causes the phone call to be picked up if a call is ringing, and to terminate an active call. A triple tap on the right earbud 103 on the touch surface 112 causes an incoming call to be rejected. A rejected call can be sent to voice mail or another outcome based on the settings of the phone to which the earbuds are paired such as via Bluetooth or another wireless protocol.

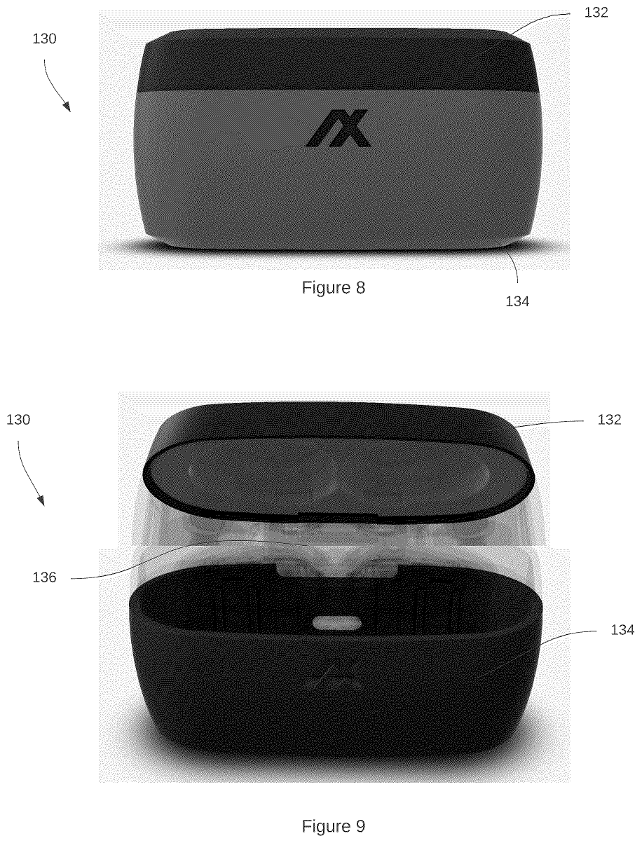

FIG. 8 is a front view of a case 130 that houses and protects the earbuds of the protective, multifunction earbud system 100 according to embodiments of the present disclosure. The case includes a lid 132 and a receptacle 134. FIG. 9 shows the case 130 according to embodiments of the present disclosure. The case 130 also includes a hinge 136 that enables the lid 132 to remain connected to the receptacle 134 when opened and closed. The hinge 136 can be a flexible, resilient member, or a rigid, mechanical hinge.

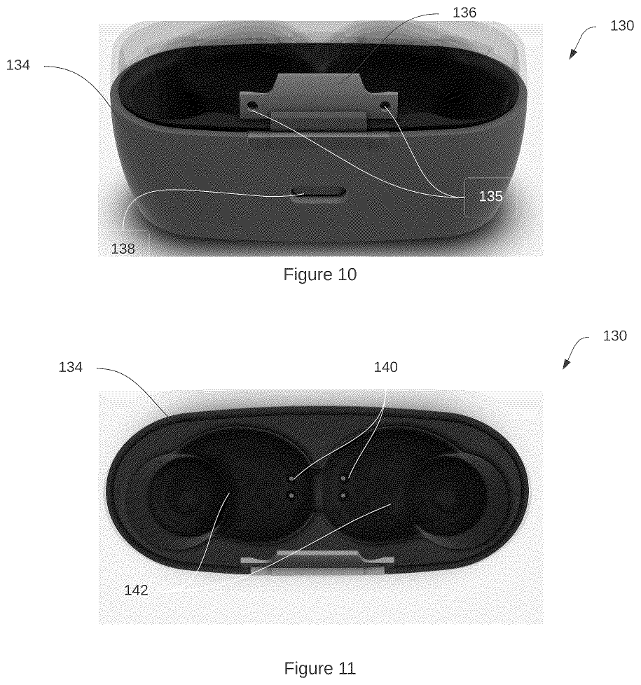

FIG. 10 shows the receptacle 134 with the lid removed according to embodiments of the present disclosure. The hinge 136 is visible and includes holes 135 used to secure the hinge 136 to the lid (not shown). The case 130 also includes a port 138 that enables a charging cord to be connected through the case 130 to the earbuds within. The port can accept all standard cord types, including but not limited to USB in all variations, Apple's Lightning, or any other suitable cord protocol that enables charging and data transfer to and from the earbuds.

FIG. 11 is a top view of the receptacle 134 according to embodiments of the present disclosure. The receptacle 134 includes contacts 140 that electrically interface with the contacts 124 shown in FIG. 5. The receptacle 134 also includes beds 142 for each earbud, right and left accordingly. The case 130 protects and provides a safe, secure way to charge the earbuds 102, 103.

The foregoing disclosure hereby enables a person of ordinary skill in the art to make and use the disclosed systems without undue experimentation. Certain examples are given to for purposes of explanation and are not given in a limiting manner.

1. A protective, multifunction earbud system, comprising:
a left earbud;
a right earbud;
wherein each of the left earbud and right earbud individually comprises:
a body having a kidney shape and being configured to house electronics including a battery, logic, wireless communication means, a microphone, and a speaker;
a stem protruding from the body and being acoustically coupled to the speaker and configured to extend into an ear canal of a wearer;
a cushion attached to the stem and being configured to facilitate a comfortable fit within the ear canal;
wherein the body fits within a concha of the wearer;
a touch surface on the body and being oriented to face outwardly from the wearer's ear, the touch surface being associated with a first plurality of predetermined commands; and
a mode swap button comprising a physical button located on a perimeter of the body, the mode swap button being associated with a second plurality of predetermined commands.

2. The protective, multifunction earbud system of claim 1 wherein the first plurality of predetermined commands include a music mode and a phone mode.

3. The protective, multifunction earbud system of claim 1 wherein the second plurality of predetermined commands include a protection level.

4. The protective, multifunction earbud system of claim 3 wherein the protection level varies between levels with consecutive presses of the mode swap button.

5. The protective, multifunction earbud system of claim 1 wherein the second plurality of predetermined commands comprises an adjustable upper limit for output sound from the speaker.

6. The protective, multifunction earbud system of claim 1 wherein the mode swap button comprises a physical button that is deflected under pressure.

7. The protective, multifunction earbud system of claim 1 wherein the touch surface comprises a capacitive touch surface that is responsive to a single tap, multiple taps within a predetermined time period, and long taps.

8. The protective, multifunction earbud system of claim 1 wherein the mode swap button comprises a capacitive button with haptic feedback.

9. The protective, multifunction earbud system of claim 1 wherein the first plurality of predetermined commands comprises:
a single tap on the left earbud for volume up;
a double tap on the left earbud for a pause/play toggle;
a triple tap on the left earbud executes a skip to the previous track;
a long press of the left earbud toggles all sound on and off;
a single tap on the right earbud for volume down;
a double tap on the right earbud for a pause/play toggle; and
a triple tap on the right earbud rejects a call or terminates an active call.

10. The protective, multifunction earbud system of claim 1 wherein the hearing protection measures comprise an upper limit on decibel output.

11. The protective, multifunction earbud system of claim 10 wherein the upper limit is approximately 85 decibels.

12. The protective, multifunction earbud system of claim 1 wherein the left earbud is shaped to fit within a left ear of a wearer and wherein the right earbud is shaped to fit within a right ear of the wearer, in each case the earbud fits within the concha of the wearer.

13. The protective, multifunction earbud system of claim 1, further comprising a case having a receptacle, a lid, a hinge, beds for the earbuds, contacts that electrically connect with the earbuds while the earbuds are within the beds, and a cable port in the receptacle through which a cable charges the earbuds through the contacts.

14. A protective, multifunctional earbud, comprising:
electronics comprising logic, a battery, a wireless transceiver, a microphone, and a speaker;
a body housing the electronics and being shaped to fit within a concha of an ear of a wearer of the earbud;
a stem protruding from the body and being configured to fit within an ear canal of the wearer and to channel sound into the ear canal of the wearer;
a touch surface on the body being responsive to capacitive touch inputs, the touch inputs being audio controls; and
a physical button on the body separate from the touch surface, the physical button being responsive to presses, wherein presses of the physical button alter digital hearing enhancement level with associated automatic digital hearing protection level of the earbud.

15. The earbud of claim 14, further comprising a second earbud generally similar to the earbud.

16. The earbud of claim 14 wherein the hearing protection levels comprise an upper limit in terms of decibels from the speaker.

17. The earbud of claim 14 wherein the physical button is on a perimeter of the body and the touch surface is on an outwardly facing surface.

18. The earbud of claim 14 wherein the hearing protection level comprises an upper decibel limit for sound output to the wearer, wherein the logic in the earbud receives sound through the microphone, digitally compresses the sound, and limits output sound to a desired decibel limit.

19. The earbud of claim 18 wherein the desired decibel limit is 85 decibels.

20. A system for protecting a wearer's hearing while providing audio outputs, the system comprising:
an earbud having a stem that fits within a wearer's ear canal and a body integral to the stem that fits within a concha of the wearer's ear;
a touch surface on the earbud being configured to receive touch inputs that control music and telephone call operation of a smartphone to which the earbud is wirelessly coupled;
logic in the earbud that receives incoming sound, digitally compresses the sound, and presents the sound to the speaker, wherein the logic limits output sound to a decibel limit of approximately 85 decibels.
